(19) United States
(12) Patent Application Publication
(10) Pub. No.: US 2016/0352841 A1
(43) Pub. Date: Dec. 1, 2016

(54) FACILITATING DYNAMIC ESTABLISHMENT OF VIRTUAL ENTERPRISE SERVICE PLATFORMS AND ON-DEMAND SERVICE PROVISIONING

(71) Applicant: AT&T Intellectual Property I LP, Atlanta, GA (US)

(72) Inventors: Sangar Dowlatkhah, ALPHARETTA, GA (US); Venson Shaw, KIRKLAND, WA (US)

(21) Appl. No.: 14/723,841

(22) Filed: May 28, 2015

(51) Int. Cl. H04L 29/08; G06F 9/445

(52) U.S. Cl. CPC H04L 67/16; G06F 8/61; H04L 67/34

(57) ABSTRACT

Dynamic establishment of virtual ESPs and on-demand service provisioning are facilitated. One system comprises: a memory that stores executable instructions; and a processor, coupled to the memory, that facilitates execution of the executable instructions to perform operations. The operations comprise: receiving, via a network device of a network that assists with communication between a virtual ESP device and the system (which can be main ESP associated with the service provider), electronic information indicative of a request for a selected service to be installed on a defined device associated with the virtual ESP device. The operations also comprise utilizing an API between the system and a subsystem associated with the selected service to install the selected service on the device, via the network device, wherein installation of the selected service is performed in response to a request for the selected service.

### TECHNICAL FIELD

The subject disclosure relates generally to telecommunications, and to systems, apparatuses and methods of facilitating dynamic establishment of virtual enterprise service platforms (ESPs) and on-demand service provisioning.

### BACKGROUND

Currently the lead time to establishment of a service is too great and too costly. For example, lead time can be up to 18 months and can result in a capital and operational expenditure of millions of dollars. Further, the result can be a limited and rigid framework with little to no space for service expansion. Due to the lead time and financial risk, creating services that could appeal to different segments of markets is difficult. In a conventional situation, the fundamental functions and network elements must typically be created (or the functions and/or network elements that already exist must be augmented), and connection to customer entity premises must typically be created or expanded via physical visit to the customer entity location by installation personnel. Further, if possible, proprietary equipment in the customer entity network must be located to accommodate the service to be implemented. To create a virtual private network (VPN) connection to customer entity premises can take between six and nine months, which is unacceptable with today's fast pace of development.

### BRIEF DESCRIPTION OF THE DRAWINGS

FIG. 1 illustrates an example schematic diagram of a system that facilitates dynamic establishment of virtual ESPs and on-demand service provisioning in accordance with one or more embodiments described herein.

FIG. 2 illustrates an example schematic diagram of a system including a virtual ESP and that facilitates dynamic establishment of virtual ESPs and on-demand service provisioning in accordance with one or more embodiments described herein.

FIG. 3 illustrates an example block diagram of an application programming interface (API) management function device of the ESP system of FIGS. 1 and 2 in accordance with one or more embodiments described herein.

FIG. 4 illustrates an example block diagram of customer entity data storage of the ESP system of FIGS. 1 and 2 in accordance with one or more embodiments described herein.

FIG. 5 illustrates an example block diagram of a table of customer entity information stored in the local ESP system of FIG. 2 in accordance with one or more embodiments described herein.

FIG. 6 illustrates an example block diagram of a table of multiple customer entity information in the ESP system of FIGS. 1 and 2 in accordance with one or more embodiments described herein.

FIGS. 7, 8 and 9 are flowcharts of methods that facilitate dynamic establishment of virtual ESPs and on-demand service provisioning in accordance with one or more embodiments described herein.

FIG. 10 illustrates a block diagram of a computer that can be employed in accordance with one or more embodiments.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard).

As used in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “Node B (NB),” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies. Further, the terms “femto” and “femto cell” are used interchangeably, and the terms “macro” and “macro cell” are used interchangeably.

Currently the lead time to establishment a service is too great and costly. Lead time can be up to 18 months and can result in a capital and operational expenditure of millions of dollars. Further, the result can be a limited and rigid framework with little to no space for service expansion. Due to the lead time and financial risk, creating services that could appeal to different segments of markets is limited. In a conventional situation, the fundamental functions and network elements must typically be created (or augmented the functions and/or network elements already exist), and connection to customer entity premises must typically be created or expanded by on-site installation personnel. Further, if possible, proprietary equipment in the customer entity network must be located to accommodate the service to be implemented. To create a VPN connection to customer entity premises can take between six and nine months, which is unacceptable with today's fast pace of development.

Additionally, enterprise subscribers are becoming more advanced and are using machine-to-machine networks with smarter devices and demanding more advanced services for businesses. The conventional time lag for service establishment for these tailored services, which could have short and demanding life spans, or a small initial service establishment as proof of concept potentially later becoming a major service offering, may fall short of expectations.

Various embodiments can include systems, apparatus, methods and/or computer-readable storage media that facilitate dynamic establishment of virtual local ESPs. In one embodiment, a system is provided. The system can comprise a memory that stores executable instructions; and a processor, coupled to the memory, that facilitates execution of the executable instructions to perform operations. The operations can comprise receiving, by a network device of a network that assists with communication between a local enterprise service platform system and the system, electronic information indicative of a request for installation of a selected service on a device associated with the local enterprise service platform system. The operations can also comprise utilizing an application programming interface to a subsystem associated with the selected service to install the selected service on the device, via the network device, wherein installation of the selected service is performed in response to a request for the selected service.

In another embodiment, a method is provided. The method can comprise receiving, by a network device comprising a processor and associated with a first enterprise service platform system, from a customer entity network associated with a customer entity, electronic information indicative of a request for instantiation of a virtual enterprise service platform at the customer entity network. The method can also comprise facilitating, by the network device, transmission of first information from the first enterprise service platform system to the customer entity network for instantiation of the virtual enterprise service platform, wherein the instantiation of the virtual enterprise service platform is performed in response to receipt of the electronic information.

In yet another embodiment, a computer-readable storage device is provided. The computer-readable storage device stores executable instructions that, in response to execution, cause a system comprising a processor to perform operations. The operations can comprise detecting first information generated indicative of a request for instantiation of a selected service on a first device. The operations can also comprise facilitating transmission of an application programming interface from a second network to create the selected service on the first device in the first network, wherein the facilitating is performed on demand in response to a request generated at a second device in the first network.

One or more embodiments can facilitate the ability to instantiate a new virtual local ESP for a customer entity at the location of a customer entity network with the capability of utilizing existing services offered by a network service provider in addition to services provided via the virtual local ESP described herein. One or more embodiments can utilize existing elements in a network while achieving a dynamic service platform in which one or more different tailored services can be created on demand dynamically in real time (e.g., within a short time frame on the order of a few seconds or a few minutes). One or more embodiments can reduce data traffic back to the network by 70%-80%, facilitate on demand deployment of new services and/or augmentation of existing services, and/or facilitate reduction of the amount of capital and operating expenditures by virtualization of an entire ESP as software running on off-the-shelf or specialized hardware.

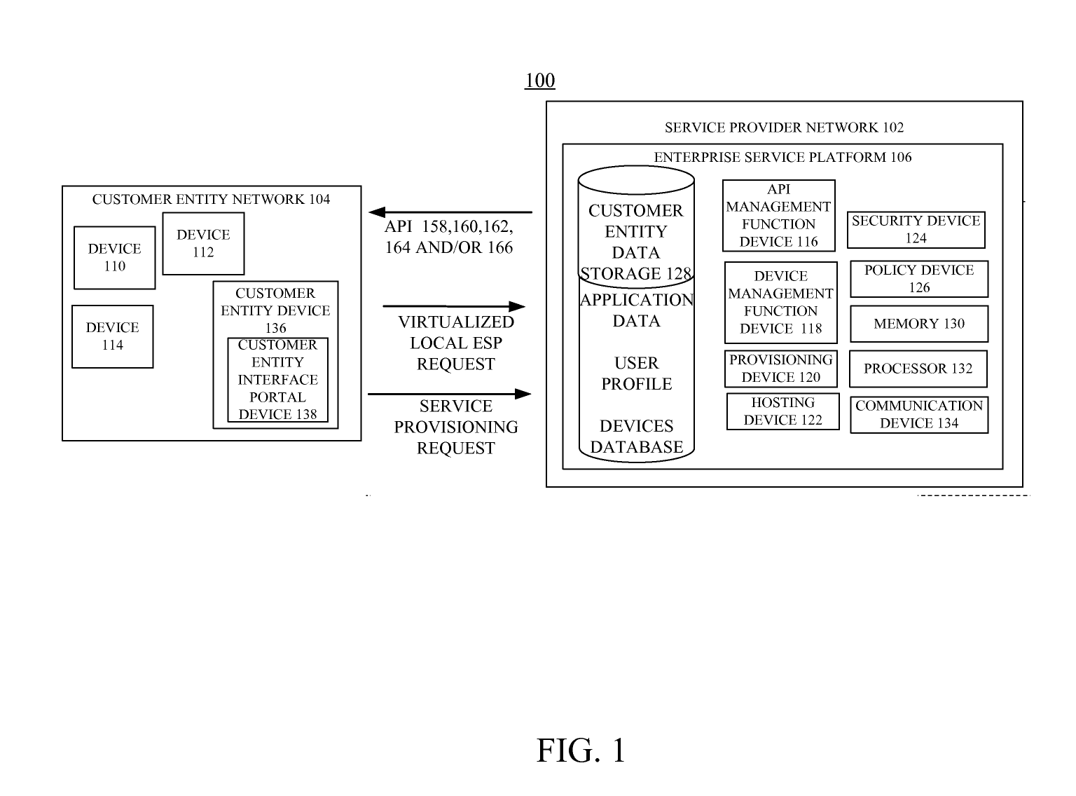

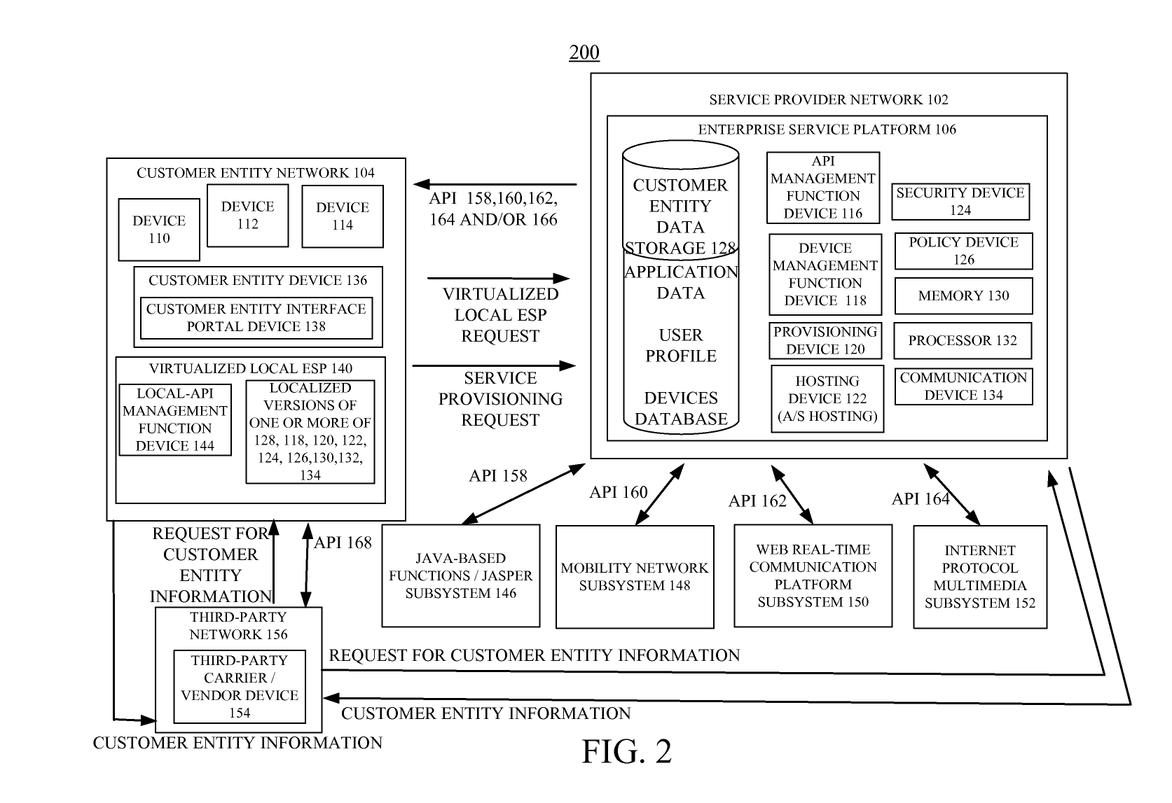

Turning now to the drawings, FIG. 1 illustrates an example schematic diagram of a system that facilitates dynamic establishment of virtual ESPs and on-demand service provisioning in accordance with one or more embodiments described herein. FIG. 2 illustrates an example schematic diagram of a system including a virtual ESP and that facilitates dynamic establishment of virtual ESPs and on-demand service provisioning in accordance with one or more embodiments described herein. Repetitive description of like elements employed in other embodiments described herein is omitted for sake of brevity.

With reference to both FIGS. 1 and 2, systems 100 and 200 can comprise a service provider network 102 and a customer entity network 104. In some embodiments, the customer entity network 104 can be software, hardware or a combination of software and hardware established at one or more processors (not shown) (e.g., x86 processor, customer entity device 136) or machines (e.g., personal computers (PCs) or laptops) located at a customer entity premises. In other embodiments, the customer entity network 104 can be provided at any location suitable to the customer entity and therefore can be located remote from the customer entity premises while being electrically and/or communicatively coupled to one or more components at the customer entity premises. The service provider network 102 and the customer entity network 104 can be electrically and/or communicatively coupled to one another to facilitate dynamic establishment of one or more virtual ESPs and/on on-demand service provisioning at the customer entity network 104.

In various embodiments, the customer entity network 104 and the service provider network 102 can be any of a number of different types of networks that facilitate communication between the customer entity network 104 and the service provider network 102 and establishment of a virtual ESP system in the customer entity network 104 based on one or more operations at the ESP system 106 of the service provider network 102.

As shown, in some embodiments, the service provider network 102 can comprise an ESP system 106. In various embodiments, the ESP system 106 can be embodied as one or more devices having hardware, software or a combination of hardware and software designed and/or configured to instantiate or facilitate instantiation of a virtual ESP 140 (as shown in FIG. 2) in the customer entity network 104 and/or to provide service provisioning to one or more devices 110, 112, 114 associated with the customer entity network 104.

The ESP system 106 can comprise various functionality, services, product management tools and/or dedicated repositories and/or serve as a master controller platform with capability of creating, instantiating and/or generating on demand virtual ESPs locally in customer entity networks (e.g., customer entity network 104) although the ESP system 106 is located in a domain of a telecommunication carrier. Shown in ESP system 106 is one mere embodiment of functionality, services, product management tools and/or dedicated repositories for ESP system 106. In other embodiments, other functionality, services, product management tools and/or dedicated repositories may or may not be included in the ESP system 106 and/or may differ from those shown in FIGS. 1 and 2.

As shown, the ESP system 106 can comprise different components and/or devices to establish one or more virtual ESPs at the customer entity network 104 and/or to provide on-demand service provisioning at the customer entity network 104 (or at one or more devices 110, 112, 114 or customer entity device 136) associated with the customer entity network 104. In the embodiment shown, the ESP system 106 can comprise an API management function device 116, device management function device 118, provisioning device 120, hosting device 122, security device 124, policy device 126, customer entity data storage 128, memory 130, processor 132 and/or communication device 134. In various embodiments, one or more of the API management function device 116, device management function device 118, provisioning device 120, hosting device 122, security device 124, policy device 126, customer entity data storage 128, memory 130, processor 132 and/or communication device 134 can be electrically and/or communicatively coupled to one another to perform one or more functions of the ESP system 106.

As also shown, the customer entity network 104 can comprise a customer entity device 136 having or being communicatively coupled to a customer entity interface portal device 138. For example, the customer entity interface portal device 138 can be directly coupled to the customer device 136 or communicatively coupled to the customer device 136 over a network (not shown). The customer entity network 104 can be associated with a particular customer entity (e.g., Customer entity A, Customer entity B). In some embodiments, the customer entity network 104 can also comprise device 110, 112, 114, which can be associated with one or more entities or subscribers of the customer entity. For example, the entity or subscriber of the customer entity can be an employee of the customer entity or the customer entity itself.

While the ESP system 106 is a multi-tenant ESP and is therefore configured to store information for and/or service multiple customer entities, the local ESP system 140 shown in FIG. 2 instantiated on the customer entity device 136 is a single customer entity ESP provided for the use of the customer entity associated with the customer entity network 104. In some embodiments, the customer entity device 136 can be a system device for the customer entity (e.g., a device to which administrators for the customer entity have access for control of the various functionalities and/or capabilities of the customer entity network 104).

In some embodiments, the virtualized local ESP system (e.g., local ESP system 140 of FIG. 2) located in the customer entity network 104 can be established on a universal platform with a direct connection to the ESP system 106. The local ESP system 140 can vary in size and/or complexity in different embodiments from time to time. For example, the local ESP system 140 can be elastic such that different services or functionalities can be added to or removed from the local ESP system 140 on demand and, in some embodiments, in substantially real-time (based on a request generated by the customer entity via the customer interface portal device 138).

As such, one or more embodiments can reduce service establishment time, capital and operational expenditures spending for customer entities and the service provider as well as enable the service provider to provide one or more services on a trial basis with customer entities, and that are tailored and specific to customer entity needs, without major risks. In some embodiments, service providers can deliver, establish or otherwise rollout, in a very short timeframe, at a customer entity network 104, one or more different tailored services requested via the customer entity interface portal device 138.

As will be described in greater detail, and as shown with reference to FIG. 2, in some embodiments, information generated and/or stored in or via the local ESP system 140 can be accessed by third-party network 156 and/or a third-party carrier/vendor device 154 of third-party network 156 in some embodiments if the customer entity has authorized such access. For example, the customer entity can authorize such access via one or more permissions established with and/or saved in the policies and/or security rules at instantiation of the local ESP system 140 or after instantiation (and during operation) of the local ESP system 140.

The customer entity interface portal device 138 can be configured to display or output information associated with one or more questions that can be answered or one or more options that can be selected or activated to generate the virtual local ESP system 140. In some embodiments, the customer entity interface portal device 138 can be a graphical user interface that displays any of a number of different types of information (e.g., text, images, graphics, video, etc.). Further, the customer entity interface portal device 138 can be communicatively coupled to the Internet (not shown) and/or can be an HTTP-based portal that displays and/or outputs information about different aspects of the virtual local ESP system that the customer entity network 104 will have instantiated as the local ESP system 140. The local ESP system 140 can be tailored to be instantiated to comprise the specific services and/or applications to best serve the customer entity and the setup can be based on information selected and/or input to the customer entity interface portal device 138.

In this regard, in some embodiments, the components, services and/or applications of the local ESP system 140 instantiated at the customer entity network 104 can be similar to or the same set of devices, applications and/or services of the ESP system 106. In other embodiments, the local ESP system 140 can be a subset of the devices, applications and/or services of the ESP system 106. Accordingly, one or more devices, applications, systems and/or functionalities of the ESP system 106 can be virtualized within the customer entity network 104. For example, software associated with and/or causing the operation of one or more applications can be stored in the memory (not shown) of the customer entity device 136 and a processor (not shown) of the customer entity device 136 can execute one or more instructions associated with the application to cause the application to operate.

The software (e.g., computer executable instructions) of the application that instantiates the virtualized ESP system 140 can be stored on hardware associated with one or more components of the customer entity network 140. For example, in some embodiments, the software can be loaded on a customer entity device (e.g., customer entity device 136) that has a defined hypervisor. As used herein, the term “hypervisor” means a virtual machine monitoring device that creates and/or run virtual machines. The hardware/customer entity device 136 (or other machine employed) can be considered the host machine and the virtual local ESP system (e.g., virtual local ESP system 140) can be or be included as part of the guest machine. In some embodiments, the hypervisor can present the guest operating systems with a virtual operating platform and manage the execution of the guest operating systems. Multiple instances of a variety of operating systems can share the virtualized hardware resources.

Similar to loading the software to the hardware that has the predefined hypervisor, the same can be done to a transport and backhaul network with virtual provider edge and customer entity edge for a particular customer entity in a multiprotocol label switching (MPLS) network. Accordingly, the VPN can be created in the same instance the virtual ESP system 140 is instantiated. As used herein, a MPLS network is a telecommunication network that directs data from one network node to another network node based on short path labels rather than long network addresses (and thereby avoiding or reducing the use of complex lookups in a routing table). The labels identify virtual links between distant nodes rather than endpoints and MPLS can encapsulate packets of various different network protocols.

As such, the ESP system 106 can instantiate one or more dedicated, tailored services that a customer entity can execute and for which the customer entity can correspondingly store customer entity information as a single platform owner with that customer entity locally (e.g., at the ESP system 140). In some embodiments, the ESP system 106 can sync information generated by the local ESP system 140 with a master platform (e.g., ESP system 106) in the service provider network 120.

As such, if the customer entity requests installation of another service (e.g., performed via entry of information at the customer entity interface portal device 138), this virtual service can be installed within a few seconds or a few minutes, and that service can address the needs the customer entity employing the service provider network 102. Accordingly, the ESP system 106 can enable the customer entity to have a dedicated portal device at the customer entity premises within the customer entity network 104 to one or more (or, in some embodiments, all) devices that are being serviced by the service provider at the network 102. For example, devices could be customer entity cell phones, tablets and/or machine-to-machine devices, comprising, but not limited to, thermostats and sensors. In some embodiments, the service provider can offer the customer entity a number of services either within the same virtual local ESP system or by creating a new virtual service with which the customer entity can have an unlimited number of virtual platforms in the customer entity network 104.

In some embodiments, the customer entity device 136 can comprise an x86 platform system with a hypervisor and service provider software that a virtual service will run on top of the hypervisor. One or more services and/or functionalities can be prepared for the one or more services stored in the ESP system 106 (or the API management function device 116 of the ESP system 106) that can generate and/or output a set of information detailing the APIs to be selected and/or any additional processing to be performed (upon selection of the service at the customer entity device 136).

The local ESP system 140 can then serve as a component for facilitating on-demand service provisioning for the customer entity and/or the customer entity can access the ESP system 106 for on-demand service provisioning at the option of the customer entity. As used herein, service provisioning comprises, but is not limited to, adding or removing or further tailoring services to the customer entity device 136 or one or more of devices 110, 112, 114.

Further, in some embodiments, no virtual ESP system need be provided at a particular customer entity network. For example, for small customer entities having less than a defined number of devices, or failing to satisfy other criterion, which can change from time to time, the customer entity can access the ESP system 106 for on-demand service provisioning in lieu of direct access to a local ESP system at the network of the customer entity.

By way of example, but not limitation, the information displayed and/or output via the customer entity interface portal device 138 can comprise inquiries such as, but not limited to, how many subscriber devices (e.g., devices 110, 112, 114) the customer entity network 104 serves or expects to serve, what types of tools would the customer entity network 104 comprise (e.g., customer entity travel tools, customer entity factory assembly line tools, customer entity machinery tracking or monitoring tools, tools to track billing and/or usage for particular devices associated with the customer entity or the like).

In some embodiments, the API management function device 116 of the ESP system 106 can receive the information and/or generate the output of the inquiries via the customer entity interface portal device 138 and process information and/or answers to the inquiries received via the customer entity interface portal 138. In some embodiments, if the customer entity network 104 provides access to the API management function device 116, the API management function device 116 can survey the customer entity network 104 and determine various conditions of the customer entity network 104 (e.g., the number of devices associated with the customer entity network 104) without need for data to be entered at and/or received via the customer entity interface portal device 138 and/or to result in a more efficient and accurate information retrieval process.

The API management function 116 can process the information obtained and/or determined about the customer entity network 104 and/or can cause the local ESP system 140 to be instantiated on the customer entity network 104 based on the processed information. Accordingly, the set or subset of functionality that will be provided via the local ESP system 140 can be based on the processed information. In some embodiments, the API management function device 116 can instantiate one or multiple local ESP systems at a single customer entity network (e.g., one local ESP for multiple services or multiple local ESPs, each having a single service).

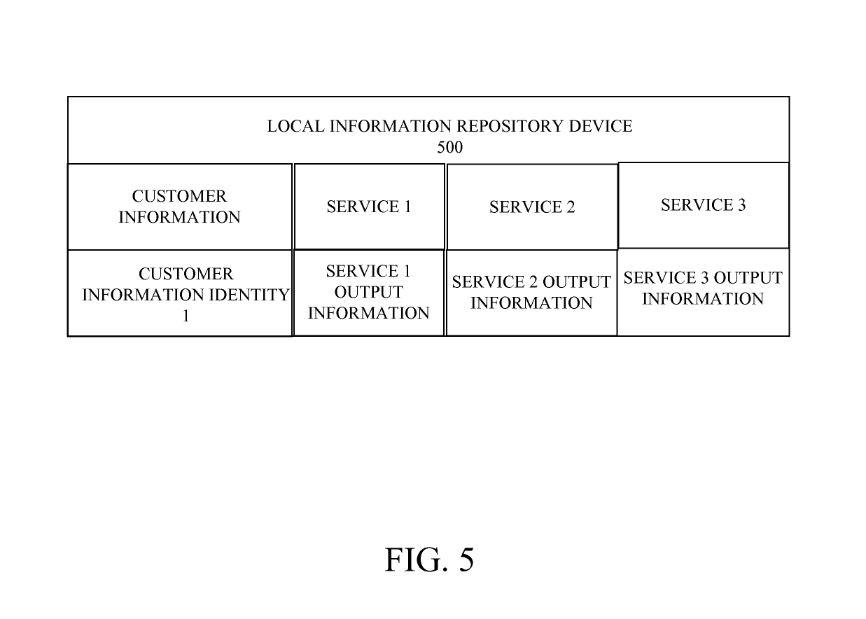

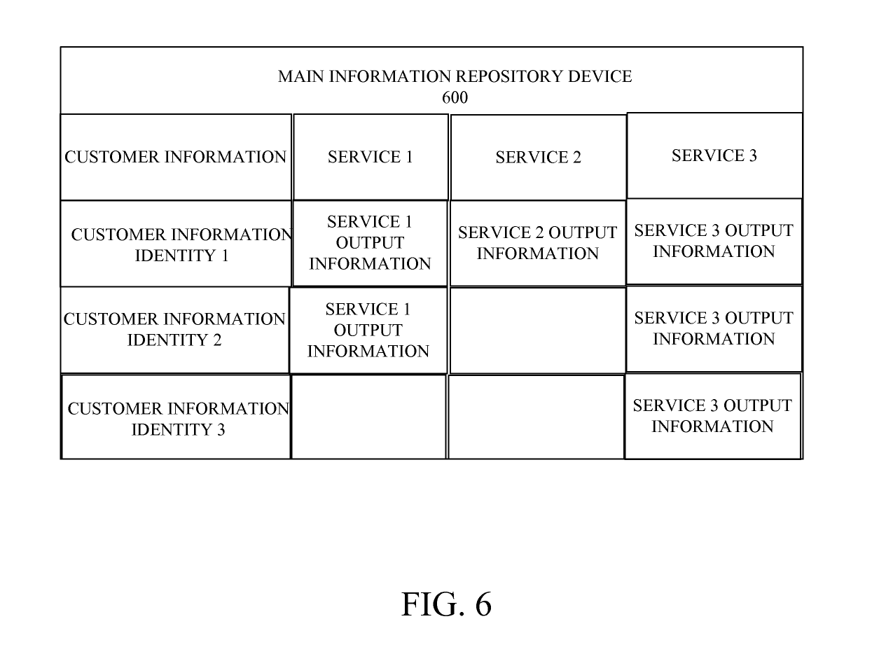

In various embodiments, the API management function device 116 (or local-API management function device 144 once a local ESP system 140 is instantiated at the customer entity network 104) can perform numerous different functions comprising, but not limited to, selection of one or more APIs (e.g., APIs 158, 160, 162, 164, 166) for provisioning services and provisioning third-party carrier/vendor access to the local ESP system 140. The API management function device 116 (or local-API management function device 144) can determine that a particular third-party to the customer entity is authorized by the customer entity to have access to customer entity information (e.g., information about or generated by the customer entity, about or generated by one or more applications and/or devices associated with the customer entity such as that shown and later described with reference to FIGS. 5 and 6).

In some embodiments, the local API management function device 116 (or local-API management function device 144) can also provide information to third-party carriers and vendors (e.g., the local API management function device 116 can also provide information to third-party carrier devices and third-party vendor devices) (e.g., third-party carrier/vendor device 154) associated with a third-party network 156.

The third-party carrier devices and third-party vendor devices can be those that are associated with a particular customer entity. As such, a customer entity can have vendors that can access information of the customer entity. The information can also be available to other carriers (e.g., Verizon) with which the customer entity may be associated. For example, if a particular customer entity has an assembly line and a sensor associated with, electrically or communicatively coupled to the assembly line outputs information that indicates the particular customer entity has a low quantity of a particular part needed or employed on the assembly line, the information output can be transmitted to and/or accessed by the customer entity data storage 128 at the ESP system 106 or the local customer entity data storage at the local ESP system 140. The third-party vendor device 154 can have a third-party API 168 access to the customer entity information (e.g., particular part is low quantity) in some embodiments, and therefore the vendor can be alerted to ship the part to the customer entity according to the information stored and/or received from the sensor into the customer entity data storage 128. The third-party can have access to the third-party API 168 based on having the API 168 transmitted to the third-party carrier/vendor device 154 based on instructions issued by the API management function device 116 (or the local-API management function device 144) based on one or more policies of the customer entity indicating that the particular third-party may have access to the customer entity information. In various embodiments, the customer entity can specify types or amounts of different information that different vendors or carriers can access.

In some embodiments, the API management function device 116 (or local-API management function device 144) can determine what API (e.g., of APIs 158, 160, 162, 164, 166) should be provided to which customer entity, third-party or the like to achieve the policy that the customer entity has requested or that the customer entity has indicated for storage in or implementation by the policy device 126.

In various embodiments, the instantiation of a local ESP such as local ESP system 140 can be initiated within several seconds or minutes after the request is generated at the customer entity interface portal device 138. As such, in some embodiments, a local ESP can be virtualized over a network without resort to one or more personnel traveling to the location of the customer entity premises and/or customer entity network and/or without need for delivery of physical components to the customer entity premises and/or customer entity network to manage and/or perform the functions of the local ESP device 140. Accordingly, on-demand substantially real-time instantiation of a virtual local ESP at a customer entity network 104 can be accomplished in an efficient and cost-effective manner thereby resulting in greater customer entity satisfaction and the like.

After instantiation of the local ESP system 140 and/or based on access, by the customer entity network 104, of the ESP system 106, the customer entity interface portal device 138 can display and/or output one or more indicators that describe one or more services that are likely to be of interest to the customer entity, one or more services being promoted to the customer entity by the service provider entity or the like.

The customer entity interface portal device 138 can receive information selecting one or more displayed options and thereby choosing one or more services and/or one or more actions to be taken with regard to the one or more services. For example, the information selected can be indicative of one or more actions to be taken for service provisioning at the customer entity network 104. Accordingly, the service provisioning can comprise, but is not limited to, adding a new service to the customer entity network (or already provided to one or more of customer entity device 136 and/or one or more of devices 110, 112, 114) (e.g., provisioning devices 110, 112, 114 with fleet management services or with billing and/or usage monitoring services); adding a new service to an existing service already provided to the customer entity network (or already provided to one or more of customer entity device 136 and/or one or more of devices 110, 112, 114) (e.g., adding selected bandwidth or display options for existing video conferencing services to certain devices associated with certain entities (e.g., executives) within the customer entity); removing a service from the customer entity network (or from one or more of customer entity device 136 and/or one or more of devices 110, 112, 114) (e.g., removing travel-related services if the customer entity has begun outsourcing such services); and/or removing one or services from an existing service (e.g., removing billing monitoring services from device 112).

By way of example, but not limitation, in some embodiments, the customer entity interface portal device 138 receives an input indicative of a request to add a service to the customer entity network 104, the customer entity device 136 and/or one or more of devices 110, 112, 114. In an embodiment in which the customer entity does not have a local ESP 140, the API management function device 116 can receive the request generated from the customer entity interface portal device 138. In embodiments in which the customer entity has a local ESP 140, the local-API management device 144 can receive the request generated from the customer entity interface portal device 138.

In either case, API management function device 116 (or the local-API management function device 144) can evaluate the request and transmit a request for an API (e.g., one of APIs 158, 160, 162, 164, 166, for example) for the specific type of service requested to be added (or for the specific type of service requested to be removed or for the specific type of service to be added on to an existing service). The API management function device 116 (or the local-API management function device 144) can transmit the API request to one or more devices of the ESP system 104, local ESP system 140 and/or subsystems 146, 148, 150, 152.

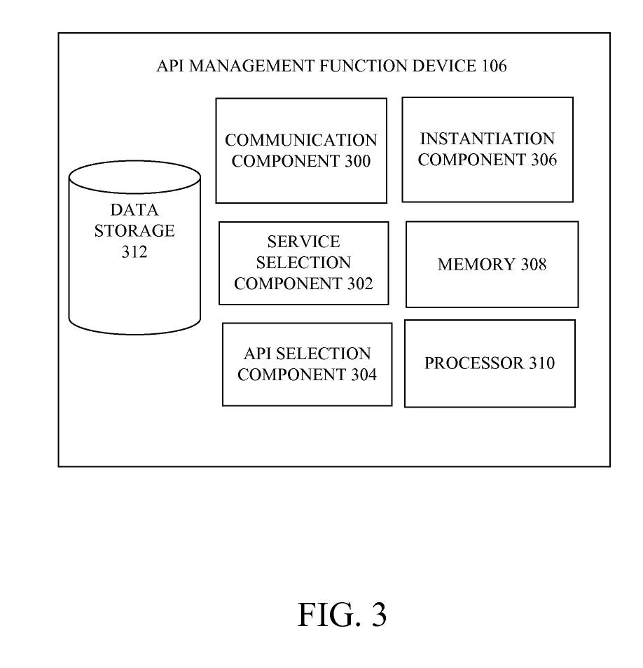

API management function device 116 will be described in greater detail with reference to FIG. 3. FIG. 3 illustrates an example block diagram of an API management function device of the ESP system of FIGS. 1 and 2 in accordance with one or more embodiments described herein. Repetitive description of like elements employed in other embodiments described herein is omitted for sake of brevity.

API management function device 116 can comprise communication component 300, service selection component 302 (which can select a service based on the service requested from the customer entity interface portal device 138), an API selection component 304 (which can identify, select and/or communicate with an API for transmission of the API to the customer entity device 136 or to another one of devices 110, 112, 114 based on the service requested), instantiation component 306 (which can generate information for instantiation of one or more virtualized local ESPs on the customer entity network 104), memory (which can be a computer-readable storage medium storing computer-executable instructions and/or information configured to perform one or more of the functions described herein with reference to the API management function device 116), processor 310 (which can perform one or more of the functions described herein with reference to the API management function device 116) and/or the data storage 312 (which can store information for operation of the API management function device 116 comprising, but not limited to, subsystems to which particular APIs are associated and the like). In various embodiments, one or more of the communication component 300, service selection component 302, API selection component 304, instantiation component 306, memory 308, processor 310 and/or data storage 312 can be electrically and/or communicatively coupled to one another to perform one or more functions of the API management function device 116.

Turning back to FIGS. 1 and 2, by way of example, but not limitation, the services to which the ESP system 106 and the ESP system 140 can have access can comprise, but are not limited to, services associated with the internet protocol multimedia system (IMS) network services (e.g., subsystem 152), mobility services (e.g., subsystem 148), web real time communication (RTC) services (e.g., subsystem 150) and/or Java-based services (e.g., subsystem 146). For example, web RTC services can comprise browser-to-browser applications associated with or that provide for voice calling, P2P file sharing and/or video chat. As another example, mobility services can comprise, but are not limited to, Internet of Things services, push-to-talk communications, machine-to-machine solutions with connected devices and applications to facilitate the IoT services, mobility enterprise management services, customized mobile applications for customer entities, mobile messaging, applications for mobile devices (e.g., smart phones), fleet management services to enable wireless tracking and monitoring of fleets, applications that enable mobile devices to be employed in any number of networks to facilitate mobile offices and the like. In some embodiments, IMS services can comprise, but are not limited to, internet protocol (IP) multimedia services such as voice over IP (VoIP) and/or Skype services.

In some embodiments, the services can be obtained via an API being transmitted from or via the ESP system 106 to the local ESP system 140 without resort to one or more of subsystem 146, 148, 150, 152, which can transmit various APIs 158, 160, 162, 164, respectively. For example, one or more of the device management function device 118, provisioning device 120, hosting device 122, security device 124, and/or policy device 126 of the ESP system 106 (or any corresponding components located in the virtual local ESP system 140) can be controlled by the API management device 118 or the local-API management function device 144) to generate an API or other software that can then install the application and/or service on the subscriber identity module (SIM) card for the requested customer entity device 136 and/or one or more of devices 110, 112, 114 that are to have the requested service provisioned.

As such, the services can be provided on demand to the customer entity device 136 and/or one or more of the devices 110, 112, 114 through transmission of the relevant APIs (e.g., APIs 158, 160, 162, 164) for the services from the subsystem 146, 148, 150, 152 or from the virtual ESP system 140 or the ESP system 106 (e.g., API 166) to the relevant device associated with the customer entity network 104. The installation in accordance with service provisioning can be performed for any number of services concurrently, simultaneously or in non-overlapping time periods. The installation can be performed for a new service in some embodiments. The services can be related or unrelated. For example, for a single customer entity, a first service instantiated can be a service for assembly line functionality, a second service can be a service for flight schedules and a third service can be for travelers associated with the customer entity.

While subsystems 146, 148, 150, 152 are described as being associated with particular types of services, in other embodiments, the subsystems 146, 148, 150, 152 can be any of a number of different types of systems that can provide any of a number of different types of services. The services from the subsystems 146, 148, 150, 152 and/or from any of the components of the ESP system 106 and/or local ESP system 140 can be provided via installation of one or more APIs from the respective subsystem or device of the ESP system 106 and/or local ESP system 140 to a SIM card for one or more of the customer entity device 136 and/or one or more of devices 110, 112, 114, as specified in the request made via the customer entity interface portal device 138. In particular, the API management function device 116 and/or the local-API management function device 144 can determine the API needed or associated with providing the requested service, can transmit an API request to the respective one of subsystems 146, 148, 150, 152 or devices of the ESP system 106 and/or local ESP system 140 and retrieve the API and subscribe the services for the requested device. The API management function device 116 and/or the local-API management function device 144 can load the API (or cause the API to be loaded) to the SIM card for the requested device. In some embodiments, the information received at the customer entity interface portal device 138 specifies a type of device or a role of a particular entity associated with the customer entity and specifies that those types of devices or entities should be subscribed to a defined one or more requested services. As such, a set of devices meeting such criteria can be provisioned based on a single request from the customer entity interface portal device 138.

In this embodiment, the API management function device 116 and/or the local-API management function device 144 can determine the profile for a particular device associated with the customer entity network 104 and subscribe the requested service on the devices that satisfy the conditions specified in the request. For example, in a request for executives to receive enhanced video conferencing with additional bandwidth while other employees receive the basic video conferencing service with standard bandwidth, the API management function device 116 and/or the local-API management function device 144 can determine which devices are associated with executives based on one or more portions or types of information for the device (e.g., profile of the device user) and can subscribe the appropriate devices with the enhanced service while subscribing the other employees with the standard service.

Referring back to the devices of the ESP system 104, in some embodiments, the components of the ESP system 106 can perform various functions towards facilitating instantiation of the virtual local ESP system 140 and/or towards service provisioning. The device management function device 118 can manage aspects of one or more services and/or one or more subscriber devices provided by the service provider to the customer entity. The device management function device 118 can manage the devices and the services to the devices wirelessly or via wired network. For example, in some embodiments, the service provider can provide a defined number of mobile phones to a customer entity. In lieu of providing the customer entity with additional hardware and/or software on-site at the customer entity premises to manage the device, the device management function device 118 can manage the device and/or services to the device wirelessly or via wired network from the device management function device 118.

The provisioning device 120 (or a local version of the provisioning device at the local ESP system 140) can provision one or more services to the devices (e.g., devices 110, 112, 114 and/or customer entity device 136) for which a request for service provisioning is made via the customer entity interface portal device 138. For example, when installing services for a particular functionality, the devices that receive the service can be further provisioned once the service is installed. By way of example, but not limitation, a video service can be installed on SIM cards of entities associated with a customer entity. The provisioning device 120 can then add additional functionality (premium functionality) to the service for selected one or more devices specified in the request for service. The provisioning can be performed over the network to the one or more devices of interest (e.g., customer entity device 136 and/or one or more of devices 110, 112, 114). As such, the installation of the premium service can be completed, in some cases, in one to two days instead of months. Further, this installation can be initiated based on a single online request initiated from the customer entity network 104.

The hosting device 122 (or a local version of the hosting device at the local ESP system 140) can provide additional services to existing services as well. The hosting device 122 can add specific features to video services for selected devices. For example, the hosting device 122 can add conferencing to video services and/or provide prioritized connectivity and/or bandwidth for different devices. As such, the hosting device 122 can provide tailored services on top of the standard services to customer entities.

Customer entity data storage 128 can be configured with database functionality and/or store information comprising, but not limited to, application data, device user profile information and/or information about devices for which installation, removal or provisioning of additional services can be performed or the like. As such, the customer entity, or devices associated with the customer entity network 104 or the customer entity, can gather information from one or more subscribers and/or devices (e.g., phones, sensor devices in assembly line or digital home environments) of one or more subscribers. The customer entity data storage 128 can store the information gathered to enable the information to be further processed and/or used. The customer entity data storage 128 can store application data, information generated by the device (e.g., sensor generates information indicated a part used on the assembly line being monitored is low in quantity). The customer entity data storage 128 can store the device generated data in the customer entity premises and/or the user information for one or more devices (e.g., customer entity device 136 and/or one or more devices 110, 112, 114) generated by the application, about the information, generated by a device or sensor employed in an application or the like.

In various embodiments, a local version of the customer entity data storage can be provided at the local ESP system 140 and can store information for only the customer entity (while the customer entity data storage 128 can store information for multiple customer entities).

Security device 124 can secure the information stored in the customer entity data storage 128 such as that shown and described with reference to FIG. 6. For example, since the ESP system 106 is a multi-tenant ESP that can service and/or store information for multiple customer entities, the security device 124 can implement one or more security rules or implement policies associated with or processed by or stored in policy device 126 about how the customer entity has approved access to information associated with the customer entity, devices, subscribers or applications or sensors, etc. of the customer entity.

The operation of the security device 124 and the policy device 126 can be tailored to the specifications desired by the particular customer entity. For example, the security device 124 and the policy device 126 can be tailored for a particular customer entity by the security device 124 and/or policy device 126 processing or executing operations with regard to communications monitored, and ensure the information associated with a particular customer entity is only able to accessed in the customer entity data storage 128 by that specific customer entity.

The policy device 126 can implement policies with regard to how the ESP system 106 or the local ESP system 140 can be utilized. For example, a customer entity with international locations can have one or more policies that restrict and/or define access to the customer entity information based on the location of the particular network. By way of example, but not limitation, a policy can be stored in the policy device 126 and/or executed by the policy device 126 that restricts and/or mandates that only traffic local to a particular network that comes from the ESP system 106 or the local ESP system 140 be transmitted to the network in this particular geographical area. Accordingly, information such as what entities can access the customer entity information (e.g. whether and which third-party carriers and/or vendors can access the customer entity information) and when the access is allowed can be stored in and/or implemented via policy device 126.

A local version of the security device at the local ESP system 140 can secure the information stored in the local customer entity data storage, such as that shown and described with reference to FIG. 5. A local version of the policy device can be stored at the local ESP system 140 and work in conjunction with the local security device to perform one or more operations for access to customer entity information according to the customer entity policies.

Memory 130 can be a computer-readable storage medium storing computer-executable instructions and/or information configured to perform one or more of the functions described herein with reference to the ESP system (or any components of the ESP system 106) and/or the customer entity data storage 128 comprising, but not limited to, evaluating security, policy and customer entity services request information and determining the APIs to transmit to customer entity devices (e.g., customer entity device 136, devices 110, 112, 114) and/or to transmit to third-party carrier/vendor devices. Although not shown, in various embodiments, the local ESP system 140 can also include local versions of memory, processors and the like.

Communication device 134 can transmit and/or receive information between the ESP system 106, the customer entity network 104, the virtualized ESP system 140, one or more of the subsystems 146, 148, 150, 152 or the like. By way of example, but not limitation, the communication device 134 can transmit one or more APIs from the ESP system 106, and/or receive one or more APIs from one or more of subsystems 146, 148, 150, 152, for transmission from the ESP system 106 to the customer entity network. In some embodiments, the communication device 134 can receive information indicative of a request for a virtualized local ESP system, or a request for service provisioning, from the customer entity network 140. In some embodiments, the communication device 134 can transmit a request for a particular API to be employed for service provisioning based on a request received from the customer entity network 104. In some embodiments, the local version of the communication device 134 can be the customer entity interface portal device 138. In other embodiments, a separate communication device can be provided at the local ESP system 140.

Accordingly, in one or more embodiments, systems 100 and 200 can process an online customer entity request for a virtualized ESP system, instantiate one or more virtualized ESP systems at the customer entity network 104 based on the request and/or based on conditions and/or number of customer entity subscribers or the like, on a single customer entity device 136 (e.g., x86 processor) via the customer entity network 104. In various embodiments, instantiation can be performed the same day as the request is received from the customer entity network in some embodiments. In some embodiments, the instantiation can be initiated within less than five minutes after the request is received from the customer entity network at the service provider network 102. As such, the request can be processed on-demand and/or in substantially real-time. The virtualized ESP system 140 can comprise the functionality of the ESP system 106 or the functionality of a subset of the ESP system 106.

Further, in some embodiments, systems 100 and 200 can receive and/or process requests from the customer entity network 104 for service provisioning. The service provisioning can be performed for the entire customer entity network 104, customer entity device 136 and/or one or more devices 110, 112, 114. Service provisioning can comprise, but is not limited to, adding one or more new services, removing one or more services, tailoring one or more existing services for specific subscriber devices to implement different levels of service, or the like.

While the embodiments have been described herein as providing service to different businesses, in some embodiments, services can be instantiated for individual consumers as well (e.g., today's smart homes, which have sensors and thermostats and cameras). These devices can be stored in the customer entity data storage and can use any device to access the information generated by the smart home network (e.g., as opposed to using only a single device, such as a FITBIT® device, to receive information from the one or more devices in the smart home network).

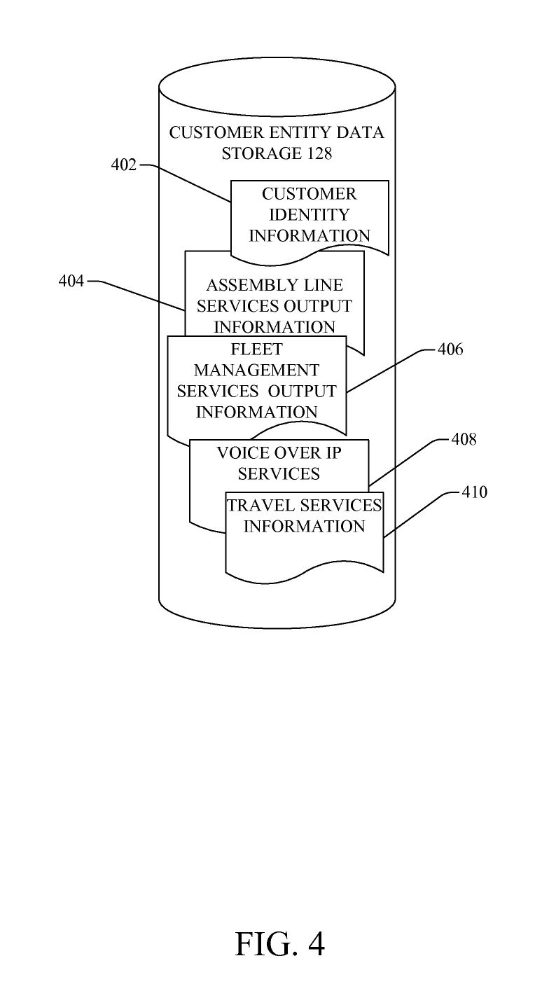

FIG. 4 illustrates an example block diagram of customer entity data storage of the ESP system of FIGS. 1 and 2 in accordance with one or more embodiments described herein. As shown, the customer entity data storage 128 can comprise a number of different types of information. In the example shown, customer entity data storage 128 can comprise customer entity identity information 402 storing information identifying the customer entity and/or one or more customer entity devices associated with the customer entity. Assembly line services output information 404 can comprise information about and generated by an assembly line service instantiated at the customer entity location. Fleet management services output information 406 can comprise information about and generated by the fleet management service comprising, but not limited to, identifiers of machinery within a fleet, location or tracking information for the machinery in the fleet and the like. Voice over IP services information 408 comprises information about the Voice over IP service instantiated at the customer entity device and/or on one or more device associated with the customer entity. Travel services information 410 comprises information about one or more travel applications instantiated at the customer entity device and/or on one or more device associated with the customer entity.

FIG. 5 illustrates an example block diagram of a table of customer entity information stored in the local ESP system (e.g., local ESP system 140) of FIG. 2 in accordance with one or more embodiments described herein. As shown in FIG. 5, the local information repository device 500 can store information about or generated by one or more selected services instantiated on a customer entity device. Accordingly, the local information repository device 500 can comprise information indicative of a first service output (e.g., service 1 output information), a second service output (e.g., service 2 output information) and a third service output (e.g., service 3 output information).

The local repository device 500 can be associated with one or more security rules and/or policy protocols that can indicate an identity of a third-party carrier or vendor (or a third-party carrier or vendor device) that can access specified information or specified types of information (e.g., information output from a particular service installed at the customer entity network). For example, the third-party carrier/vendor device 154 can access and/or receive information stored at the local repository device via a third-party API (e.g., third-party API 168) transmitted from the customer entity network 102 at the local ESP system 140 to the third-party carrier/vendor network 156.

In various embodiments, with reference to FIGS. 1 and 5, the third-party carrier/vendor device 154 can access and/or receive one or more portions of the information stored in the local repository device 700 if the security protocol conditions are met. For example, in some embodiments, the third-party carrier/vendor device can be associated with a particular identity and the security protocol condition can be that the third-party carrier/vendor device 154 is of a particular identity in order to access and/or receive information stored in the local repository device 500. Different levels of security access can be provided for different third-party carrier/vendor devices or different types of third-party carrier/vendor devices. In some embodiments, a customer entity can specify that the local information repository device can be accessed only by the customer entity device or devices affiliated or associated with the customer entity (and therefore cannot be accessed by a third-party carrier/vendor device).

FIG. 6 illustrates an example block diagram of a table of multiple customer entity information in the ESP system of FIGS. 1 and 2 in accordance with one or more embodiments described herein. Shown in FIG. 6 is a table storing information for multiple customer entity information. In some embodiments, the customer entity device (e.g., customer entity device 136 of FIG. 1) at the service provider network (e.g., service provider network 102 of FIG. 1) can access the particular customer entity information for that customer entity only from the main information repository device 600. In some embodiments, security protocols can be established and implemented to secure one or more different customer entity information such that a first customer entity can access first customer entity information but not second customer entity information.

As shown, main information repository device 600 comprises information for three different customer entities (e.g., a first customer entity associated with identity 1, a second customer entity associated with identity 2 and a third customer entity associated with identity 3). In the embodiment shown, customer entity 1 has installed services 1, 2 and 3 and main information repository device 600 stores information about or generated by services 1, 2 and 3. Customer entity 2 has installed services 1 and 3 and main information repository device 700 stores information about or generated by services 1 and 3. Customer entity 3 has installed service 3 and main information repository device 600 stores information about or generated by service 3.

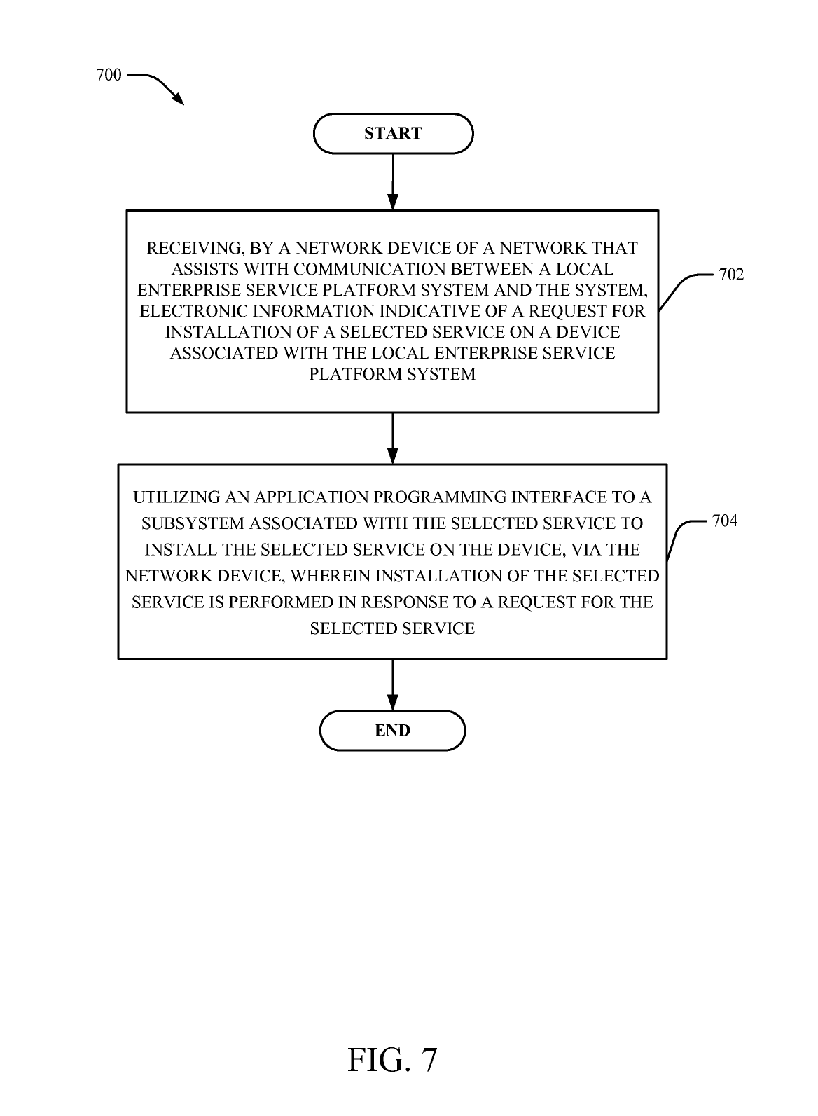

FIGS. 7, 8 and 9 are flowcharts of methods that facilitate dynamic establishment of virtual ESPs and on-demand service provisioning in accordance with one or more embodiments described herein. Turning first to FIG. 7, at 702, method 700 can comprise receiving, by a network device of a network that assists with communication between a local enterprise service platform system and the system, electronic information indicative of a request for installation of a selected service on a device associated with the local ESP system.

In some embodiments, information generated by the selected service is stored only at the local ESP system. In some embodiments, the installation can be performed in real-time (e.g., on the order of seconds or on the order of minutes) after the request for the selected service is received.

At 704, method 700 can comprise utilizing an application programming interface to a subsystem associated with the selected service to install the selected service on the device, via the network device, wherein installation of the selected service is performed in response to a request for the selected service.

In some embodiments, the third-party application programming interface is communicatively coupled between the third-party vendor device and the local enterprise service platform system. In various embodiments, the subsystem can be a internet protocol multimedia subsystem, a web real time communication subsystem and/or a mobility subsystem.

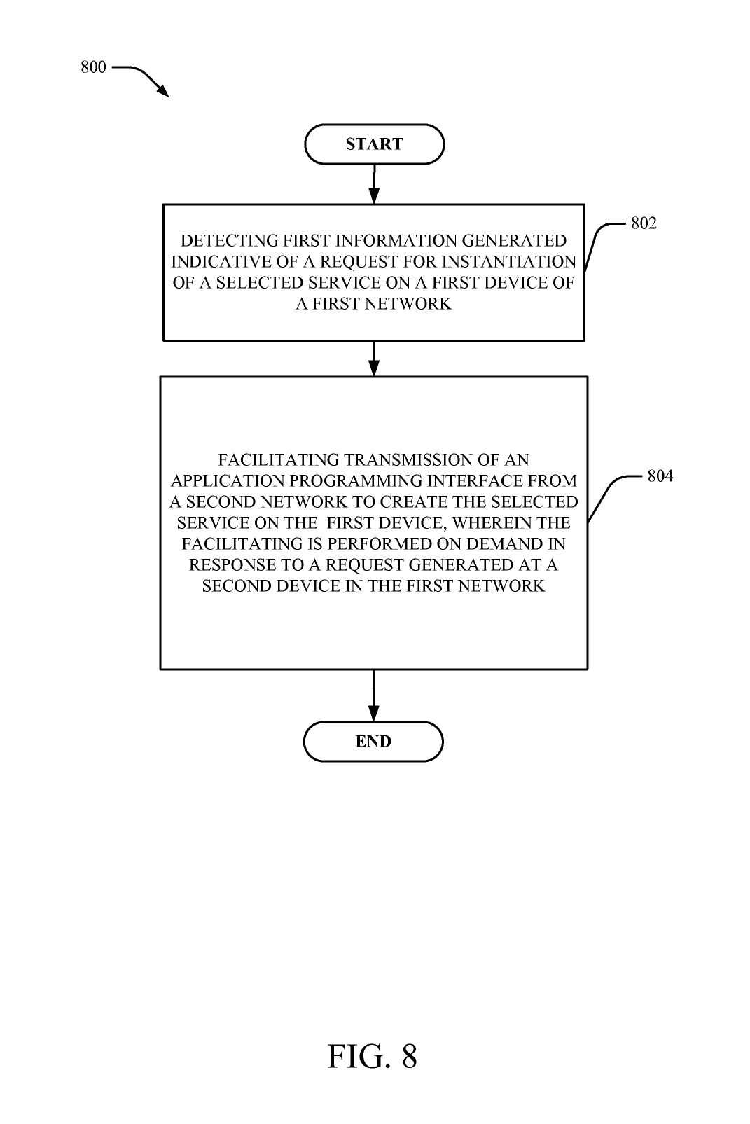

Turning now to FIG. 8, at 802, method 800 can comprise detecting first information generated indicative of a request for instantiation of a selected service on a first device of a first network. The first information can comprise the identification of the selected service. In some embodiments, the selected services can be any of a number of different types of services comprising, but not limited to, digital home services having applications associated with sensors, thermostats, etc. in a particular environment, travel services for one or more entities (e.g., employees, executives) for a company, services associated with assembly line or other processes (e.g., tracking the quantity of one or more parts employed on the assembly line) or the like.

The instantiation of the selected service on the first device can be initiated within seconds of receipt of the request for the selected service from the first device. For example, the instantiation can be performed in real-time. In some embodiments, real-time can be or comprise initiating or completing the instantiation in a matter of seconds or minutes.

At 804, method 800 can comprise facilitating transmission of an application programming interface from a second network to create the selected service on the first device, wherein the facilitating is performed on demand in response to a request generated at a second device in the first network.

In some embodiments, although not shown, second information can be generated by the selected service and can be accessible to a third-party vendor device via a third-party application programming interface communicatively coupled to the second network. In some embodiments, the second information can be stored in a repository associated with the second network and having an associated security policy facilitating access by the third-party vendor device to the information.

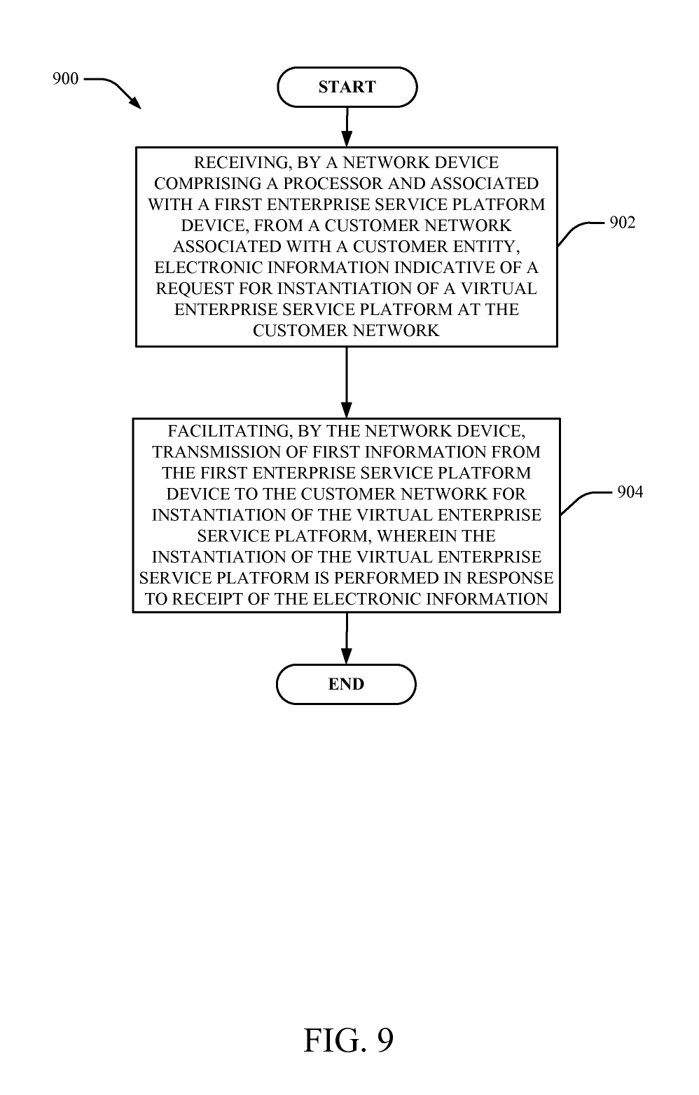

Turning now to FIG. 9, at 902, method 900 can comprise receiving, by a network device comprising a processor and associated with a first enterprise service platform system, from a customer entity network associated with a customer entity, electronic information indicative of a request for instantiation of a virtual enterprise service platform at the customer entity network. In some embodiments, the electronic information comprises second information indicative of tools to be included in the virtual enterprise service platform.

At 904, method 900 can comprise facilitating, by the network device, transmission of first information from the first enterprise service platform system to the customer entity network for instantiation of the virtual enterprise service platform, wherein the instantiation of the virtual enterprise service platform is performed in response to receipt of the electronic information. In some embodiments, the virtual enterprise service platform comprises a first set of functionality based on the tools satisfying a first defined condition and the virtual enterprise service platform comprises a second set of functionality based on the tools satisfying a second defined condition.

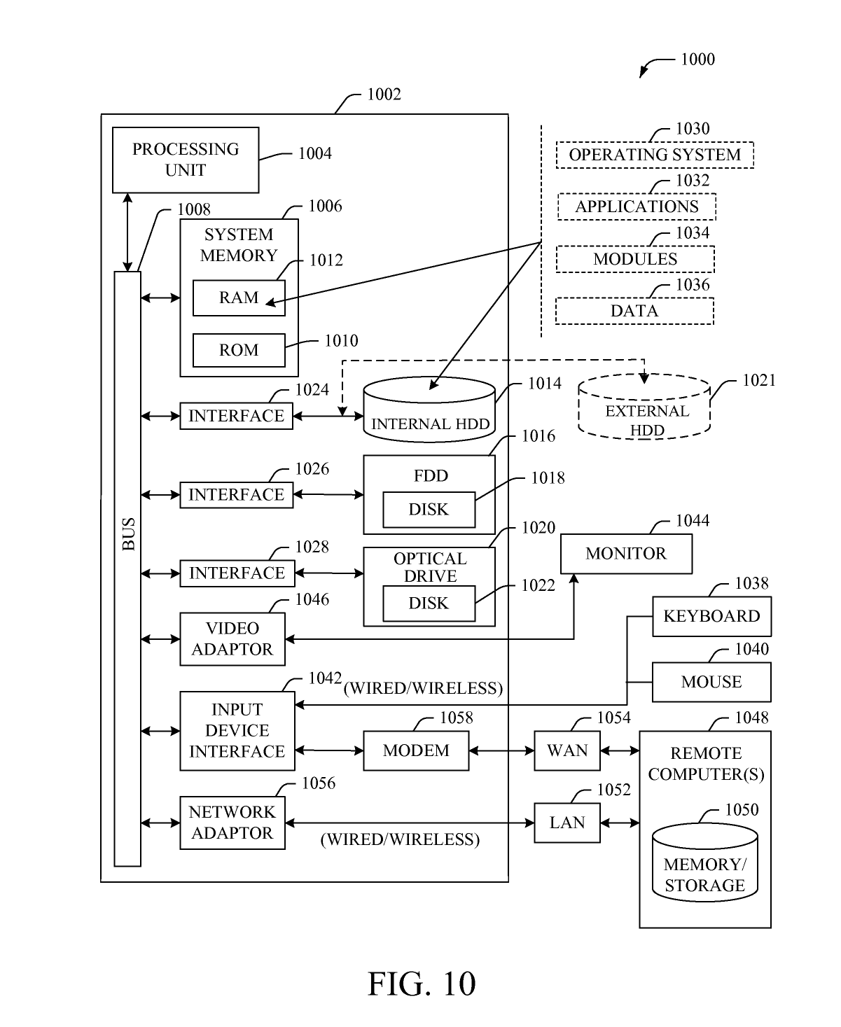

FIG. 10 illustrates a block diagram of a computer that can be employed in accordance with one or more embodiments. Repetitive description of like elements employed in other embodiments described herein is omitted for sake of brevity.

In some embodiments, the computer can be or be included within any number of components described herein comprising, but not limited to, ESP system 106, local ESP system 140, third-party carrier/vendor device 154 and/or API management function device 116 (or any components of ESP system 106, local ESP system 140, third-party carrier/vendor device 154 and/or API management function device 116).

In order to provide additional text for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules comprise routines, programs, components, data structures, etc., that perform particular tasks or implement particular abstract data types. Moreover, those skilled in the art will appreciate that the inventive methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data or unstructured data. Tangible and/or non-transitory computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage, other magnetic storage devices and/or other media that can be used to store desired information. Computer-readable storage media can be accessed by one or more local or remote computing devices, e.g., via access requests, queries or other data retrieval protocols, for a variety of operations with respect to the information stored by the medium.

In this regard, the term “tangible” herein as applied to storage, memory or computer-readable media, is to be understood to exclude only propagating intangible signals per se as a modifier and does not relinquish coverage of all standard storage, memory or computer-readable media that are not only propagating intangible signals per se.

In this regard, the term “non-transitory” herein as applied to storage, memory or computer-readable media, is to be understood to exclude only propagating transitory signals per se as a modifier and does not relinquish coverage of all standard storage, memory or computer-readable media that are not only propagating transitory signals per se.

Communications media typically embody computer-readable instructions, data structures, program modules or other structured or unstructured data in a data signal such as a modulated data signal, e.g., a channel wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1010 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface, respectively. The interface 1024 for external drive implementations includes at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

A communication device can enter commands and information into the computer 1002 through one or more wired/wireless input devices, e.g., a keyboard 1038 and a pointing device, such as a mouse 1040. Other input devices (not shown) can include a microphone, an infrared (IR) remote control, a joystick, a game pad, a stylus pen, touch screen or the like. These and other input devices are often connected to the processing unit 1004 through an input device interface 1042 that can be coupled to the system bus 1008, but can be connected by other interfaces, such as a parallel port, an IEEE 1394 serial port, a game port, a universal serial bus (USB) port, an IR interface, etc.

A monitor 1044 or other type of display device can be also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1052 through a wired and/or wireless communication network interface or adapter 1056. The adapter 1056 can facilitate wired or wireless communication to the LAN 1052, which can also include a wireless AP disposed thereon for communicating with the wireless adapter 1056.

When used in a WAN networking environment, the computer 1002 can include a modem 1058 or can be connected to a communications server on the WAN 1054 or has other means for establishing communications over the WAN 1054, such as by way of the Internet. The modem 1058, which can be internal or external and a wired or wireless device, can be connected to the system bus 1008 via the input device interface 1042. In a networked environment, program modules depicted relative to the computer 1002 or portions thereof, can be stored in the remote memory/storage device 1050. It will be appreciated that the network connections shown are example and other means of establishing a communications link between the computers can be used.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can include Wireless Fidelity (Wi-Fi) and BLUETOOTH® wireless technologies. Thus, the communication can be a defined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a femto cell device. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands, at an 11 Mbps (802.11a) or 54 Mbps (802.11b) data rate, for example or with products that contain both bands (dual band), so the networks can provide real-world performance similar to the basic 10 Base T wired Ethernet networks used in many offices.

The embodiments described herein can employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of an acquired network. A classifier is a function that maps an input attribute vector, x=(x1, x2, x3, x4, . . . , xn), to a confidence that the input belongs to a class, that is, f(x)=confidence(class). Such classification can employ a probabilistic and/or statistical-based analysis (e.g., factoring into the analysis utilities and costs) to prognose or infer an action that a communication device desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing communication device behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to a predetermined criteria which of the acquired cell sites will benefit a maximum number of subscribers and/or which of the acquired cell sites will add minimum value to the existing communication network coverage, etc.

As employed herein, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of communication device equipment. A processor can also be implemented as a combination of computing processing units.

As used herein, terms such as “data storage,” “database,” and substantially any other information storage component relevant to operation and functionality of a component, refer to “memory components,” or entities embodied in a “memory” or components including the memory. It will be appreciated that the memory components or computer-readable storage media, described herein can be either volatile memory or nonvolatile memory or can include both volatile and nonvolatile memory.

Memory disclosed herein can include volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM) or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory (e.g., data storages, databases) of the embodiments are intended to include, without being limited to, these and any other suitable types of memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
receiving, by a network device of a network that assists with communication between a local enterprise service platform system and the system, electronic information indicative of a request for installation of a selected service on a device associated with the local enterprise service platform system; and
utilizing an application programming interface to a subsystem associated with the selected service to install the selected service on the device, via the network device, wherein installation of the selected service is performed in response to a request for the selected service.

2. The system of claim 1, wherein information generated by the selected service is accessible to a third-party device via a third-party application programming interface.

3. The system of claim 2, wherein the third-party application programming interface is communicatively coupled between a third-party device and the local enterprise service platform system.

4. The system of claim 2, wherein the selected service is associated with a policy to allow access to the information by the third-party device.

5. The system of claim 2, wherein the information generated by the selected service is stored only at the local enterprise service platform system.

6. The system of claim 1, wherein the selected service is included in services accessible for installation on the device and displayed via the local enterprise service platform.

7. The system of claim 1, wherein the installation of the selected service on the device is initiated electronically via the network device within approximately ten minutes after the request for the selected service.

8. The system of claim 1, wherein the selected service generates status information about a condition associated with the selected service, and wherein the status information is stored in a repository of the local enterprise service platform system.

9. The system of claim 1, wherein the selected service generates status information about a condition associated with the selected service, wherein the selected service is a first service, and wherein the system comprises a customer entity data storage in which the status information is stored for a first customer entity service and other information is stored for a second customer entity service.

10. The system of claim 9, wherein the system comprises a security protocol enabling the status information stored for the first customer entity service to be accessible to a first customer entity identity and the other information stored for the second customer entity service to be accessible to a second customer entity identity.

11. The system of claim 1, wherein the selected service comprises a service for a digital home environment and the device comprises a sensor of the digital home environment.

12. The system of claim 1, wherein the selected service comprises a service to facilitate travel for an entity associated with a customer entity identity, and wherein the local enterprise service platform is associated with the customer entity identity.

13. The system of claim 1, wherein the installation of the selected service is performed on devices associated with the customer entity.

14. A method, comprising:
receiving, by a network device comprising a processor and associated with a first enterprise service platform system, from a customer entity network associated with a customer entity, electronic information indicative of a request for instantiation of a virtual enterprise service platform at the customer entity network; and
facilitating, by the network device, transmission of first information from the first enterprise service platform system to the customer entity network for instantiation of the virtual enterprise service platform, wherein the instantiation of the virtual enterprise service platform is performed in response to receipt of the electronic information.

15. The method of claim 14, wherein the electronic information comprises second information indicative of tools to be included in the virtual enterprise service platform.

16. The method of claim 15, wherein the virtual enterprise service platform comprises first functionality based on the tools satisfying a first defined condition and the virtual enterprise service platform comprises second functionality based on the tools satisfying a second defined condition.

17. A computer-readable storage device storing executable instructions that, in response to execution, cause a system comprising a processor to perform operations, comprising:
detecting information generated to be indicative of a request for instantiation of a selected service on a first device of a first network; and
facilitating transmission of an application programming interface from a second network device of a second network to create the selected service on the first device, wherein the facilitating is performed on demand in response to a request generated at a second device of the first network.

18. The computer-readable storage device of claim 17, wherein the information is first information, and wherein second information generated by the selected service is accessible to a third-party vendor device via a third-party application programming interface communicatively coupled to the second network device.

19. The computer-readable storage device of claim 17, wherein the second information is stored in a repository associated with the second network device and having an associated security policy facilitating access by the third-party vendor device to the second information.

20. The computer-readable storage device of claim 17, wherein the instantiation of the selected service on the first device is initiated within five seconds of receipt of the request for the selected service from the first device.
